(19) United States
(12) Patent Application Publication
(10) Pub. No.: US 2011/0013788 A1
(43) Pub. Date: Jan. 20, 2011

(54) Electret Condenser Microphone

(75) Inventors: Toshiro Izuchi, Fukuoka (JP); Kensuke Nakanishi, Fukuoka (JP); Tsuyoshi Baba, Fukuoka (JP)

Correspondence Address: THE WEBB LAW FIRM, P.C., 700 KOPPERS BUILDING, 436 SEVENTH AVENUE, PITTSBURGH, PA, 15219, US

(73) Assignee: HOSIDEN CORPORATION, Yao-shi, Osaka (JP)

(21) Appl. No.: 12/810,082

(22) PCT Filed: Nov. 4, 2008
(86) PCT No.: PCT/JP2008/070013

§ 371 Date: Sep. 15, 2010

(30) Foreign Application Priority Data
Dec. 27, 2007 (JP) 2007-337235

(51) Int. Cl. H04R 25/00

(52) U.S. Cl. 381/174

(57) ABSTRACT

An electret condenser microphone includes a conductive capsule including an opening formed in a top member, a capacitor section including a diaphragm, a back electrode plate arranged to face either surface of the diaphragm, and a electret layer provided on the diaphragm or the back electrode plate, which are housed in the capsule, and a cap member provided between the capacitor section and the top member of the capsule and including an acoustic hole formed in a portion exposed to the outside through the opening, wherein the cap member further includes a suctioned portion formed in a central portion thereof to be drawn by a suction-type transporting device, the acoustic holes being arranged along the circumference of the suctioned portion.

### TECHNICAL FIELD

The present invention relates to an electret condenser microphone (referred to as an “ECM” hereinafter) comprising a capacitor section including a diaphragm, a back electrode plate arranged to face either surface of the diaphragm, and a electret layer provided on the diaphragm or the back electrode plate, all of which are housed in a capsule.

### BACKGROUND ART

The ECM has been applied to a wide variety of electronic devices such as a mobile phone, a PDA and a digital camera, for example. The ECM is a minute element and mounted on each of the devices using surface mounting technology. For example, the reflow mounting technique is used in which solder is applied on a wiring substrate to mount the ECM thereon, and then the substrate is heated and soldered. In order to speed up in mounting the ECM on the wiring substrate, the reflow mounting process sometimes uses a suction-type transporting device to transport the ECM to the wiring substrate.

Many of the conventional ECM include an acoustic hole provided in a central portion of a top surface of the capsule acting as a housing. Thus, when using the suction-type transporting device, a portion other than the acoustic hole is drawn so as not to damage the diaphragm and the like housed in the device to transport the ECM to a predetermined position on the wiring substrate.

Patent Document 1: Japanese Utility Model Registration No. 2548543 (FIG. 1)

### DISCLOSURE OF THE INVENTION

When the conventional ECM is transported in the reflow mounting process, the portion other than the acoustic hole that is deviated from the center of gravity is drawn to transport the ECM, as a result of which it is sometimes difficult to maintain a predetermined posture of the ECM during the transportation. For example, when the transporting device contacts the vicinity of an edge of the top surface, the ECM easily inclines and sometimes falls off. On the other hand, when a drawing force of the transporting device is increased in an attempt to solve the above problem, the top surface of the capsule is disadvantageously deformed, for example, which leaves room for improvement.

In performing the reflow mounting process, it is also required to adopt a measure against heat. In the reflow mounting process, heated air is generated and sometimes enters the capsule through the acoustic hole formed in the top surface of the capsule, or the heat coming from the heated capsule is transmitted to the inner parts (diaphragm and the electret layer, for example) of the capsule. In that case, the parts housed in the capsule may be adversely affected by the heat. In addition, cooling air for cooling the capsule enters the capsule through the acoustic hole formed in the top surface of the capsule to possibly exert an adverse influence on the parts housed in the capsule. For instance, the diaphragm may be slackened by heated air or cooling air, or polarization of the electret layer may be deteriorated by the heat.

Nonetheless, the conventional ECM has not adopted any effective measure to counter the heat transmission to the inner parts from heated air, cooling air or the capsule as noted above which possibly creates the problem in the reflow mounting process.

The present invention has been made having regard to the above-noted problem, and its object is to provide an ECM suitable for suction transportation in the reflow mounting process and adopting a measure to counter the heat transmission to the inner parts from heated air, cooling air or the capsule.

In order to achieve the above-noted object, the first characteristic feature of an electret condenser microphone according to the present invention lies in comprising:

a conductive capsule including an opening formed in a top member;

a capacitor section including a diaphragm, a back electrode plate arranged to face either surface of the diaphragm, and a electret layer provided on the diaphragm or the back electrode plate, all of which are housed in the capsule; and

a cap member provided between the capacitor section and the top member of the capsule and including an acoustic hole formed in a portion exposed to the outside through the opening;

wherein the cap member further includes a suctioned portion formed in a central portion thereof to be drawn by a suction-type transporting device, the acoustic holes being arranged along the circumference of the suctioned portion.

With the above-noted arrangement, the cap member is provided between the capsule and the capacitor section. Thus, even if the capsule is heated, the heat is alleviated by the cap member and less easily transmitted to the capacitor section. As a result, the capacitor section housed in the capsule is prevented from being deteriorated. In particular, the heat influence exerted on the electret layer provided in the capacitor section can be suppressed, which can prevent deterioration of the polarization of the electret layer caused by the heat.

In addition, heated air or cooling air generated in the reflow mounting process pass through a passage narrowed by the opening of the capsule and a passage narrowed by the acoustic hole formed in the cap member to reach the capacitor section. This prevents the capacitor section from being damaged by heated air or cooling air generated in the reflow mounting process. More particularly, the diaphragm is prevented from slackening by heated air or cooling air.

Further, the suctioned portion is provided in the central portion of the top member of the capsule of the electret condenser microphone, as a result of which suction can be performed with a suction nozzle of the suction-type transporting device being aligned with the center of the top surface which substantially coincides with the center of gravity of the electret condenser microphone. This changes the posture of the electret condenser microphone less easily in transportation to perform the suction reliably. In addition, a moment exerted on a suctioned portion when performing the suction is decreased, which reduces the drawing force of the suction-type transporting device to prevent the top surface from being deformed. Further, since the acoustic hole is not present in the suctioned portion provided in the top member, the ECM is securely transported while the suction nozzle of the suction-type transporting device does not damage the diaphragm or the back electrode plate housed in the capsule by its suctioning action.

As a result, it is possible to provide the ECM suitable for suction transportation in the reflow mounting process and adopting a measure to counter the heat transmission to the inner parts from heated air, cooling air or the capsule which may pose the problem.

A second feature of the electret condenser microphone of the present invention lies in that the acoustic hole includes arc slits surrounding the circumference of the suctioned portion.

With the above-noted feature, the acoustic hole including the openings having the predetermined areas that are arranged in the positions as close to the center of the capsule as possible, which improves the sound collecting performance.

Further, the slit shape of the acoustic hole provides a smaller opening width than a circular or rectangular acoustic hole having the same area, which prevents heated air, cooling air, dust or waterdrops from easily entering the capsule. As a result, the durability and reliability of the electret condenser microphone can be improved.

The third feature of the electret condenser microphone of the present invention lies in that the cap member includes a peripheral first area and a second area defined by a central portion surrounded by the first area and projecting outward, and the suctioned portion is formed in the second area.

With the above arrangement, a space is provided between the cap member and the capacitor section housed in the capsule. As a result, even if the cap member is heated, the heat is transmitted to the capacitor section less easily.

The fourth feature of the electret condenser microphone of the present invention lies in that the acoustic hole is formed in the second area.

With the above arrangement, since the acoustic hole is formed in the second area projecting outward, a sound wave can be satisfactorily taken in through the acoustic hole from the outside.

The fifth feature of the electret condenser microphone of the present invention lies in that the acoustic hole is formed in a boundary between the first area and the second area.

With the above arrangement, the acoustic hole is formed with a predetermined angle relative to the first area and the second area, which prevents heated air, cooling air, dust and waterdrops more reliably from entering the capsule easily.

In addition, even if the suction nozzle of the transporting device is brought into contact with a position deviated from the suctioned portion, the suction nozzle would never seal the acoustic hole, which can prevent the diaphragm or the back electrode plate housed in the capsule from being damaged.

### BRIEF DESCRIPTION OF THE DRAWINGS

FIG. 1 is an exploded perspective view of an electret condenser microphone;

FIG. 2 is a sectional view of the electret condenser microphone;

FIG. 3 shows a condition in which a cap member is housed in a capsule;

FIG. 4 is a sectional perspective view (1) of the cap member;

FIG. 5 is a sectional perspective view (2) of the cap member; and

FIG. 6 is a sectional view of the cap member in accordance with a modified embodiment.

### MODE FOR CARRYING OUT THE INVENTION

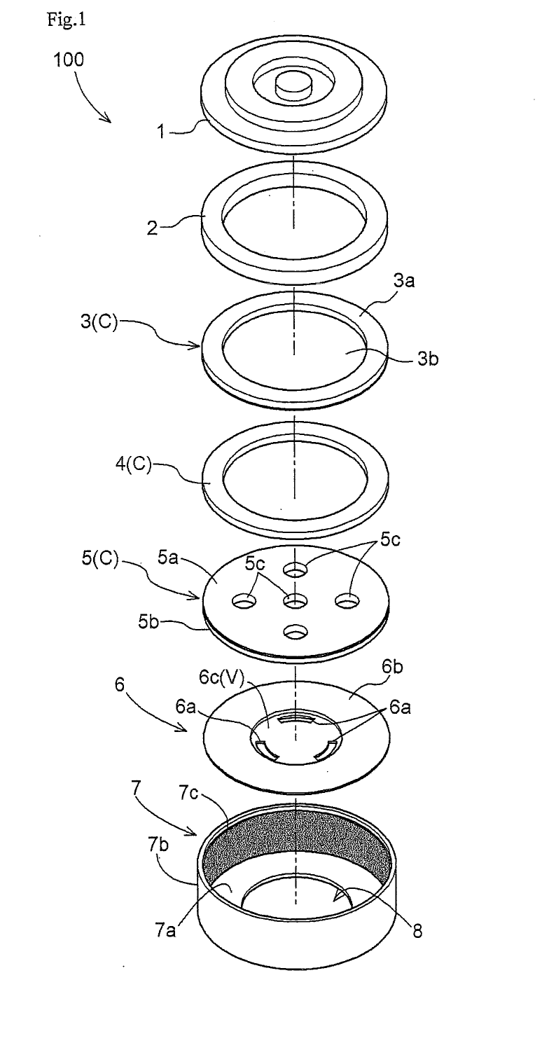

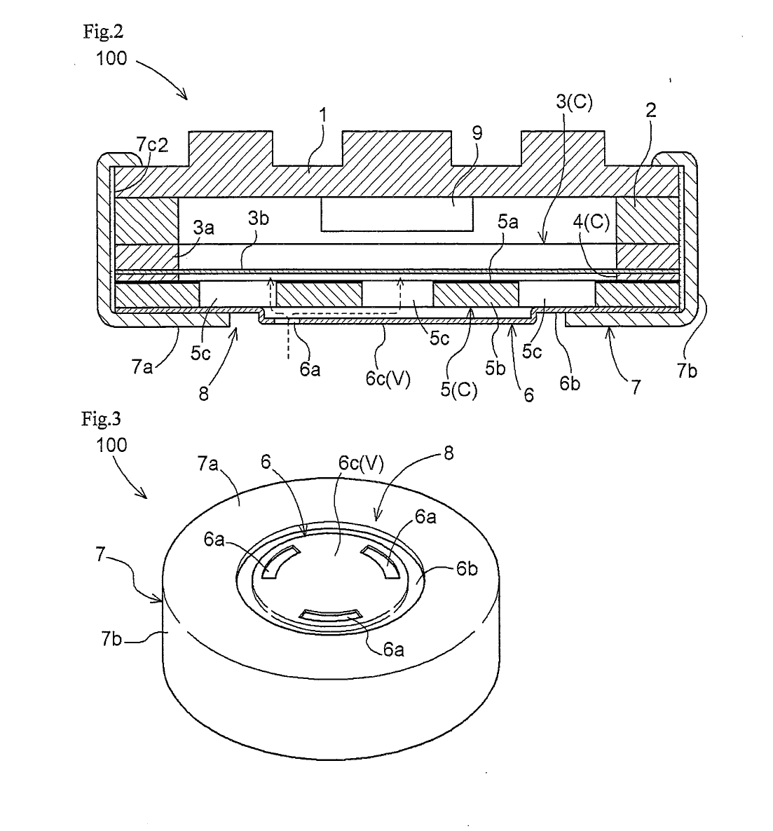

An electret condenser microphone (referred to as an “ECM” hereinafter) of the present invention will be described hereinafter in reference to the accompanying drawings. FIG. 1 is an exploded perspective view of the ECM100, and FIG. 2 is a sectional view of the ECM100.

As shown in FIGS. 1 and 2, the ECM100 comprises a capsule 7 consisting of a cylindrical side member 7b and a top member 7a, which includes various elements therein. Inside of the capsule 7 are housed, from the side of the top member 7a, a cap member 6, a back electrode plate 5, a spacer ring 4, a diaphragm 3, a gate ring 2, and a substrate 1. The side member 7b of the capsule 7 is crimped at their ends to hold the substrate 1 therein thereby fixing the various elements within the capsule 7. The capsule 7 is made of a conductive material such as metal.

In the current embodiment, the cylindrical capsule 7 will be described, while the shape of the capsule 7 may be a rectangular tube.

In the current embodiment, the back electrode pate 5, spacer ring 4, and diaphragm 3 form a capacitor section C. The capacitor section C detects a sound wave entering the interior of the capsule 7. The back electrode late 5 includes a fixed electrode 5b and an electret layer 5a mounted on a surface of the fix electrode 5b facing the diaphragm 3. Provision of the electret layer 5 allows the back electrode plate 5 to be maintained at constant potential. A plurality of apertures 5c are formed in the back electrode plate 5 and the electret layer 5a. The sound wave having entered the interior of the capsule 7 reaches the diaphragm 3 through the apertures 5c.

The diaphragm 3 includes a diaphragm membrane 3b vibrated by the sound wave, and a diaphragm membrane ring 3a for holding peripheries of the diaphragm membrane 3b. The insulating spacer ring 4 is provided between the back electrode plate 5 and the diaphragm 3. An inner wall of the capsule 7 is coated with an insulating material 7c for preventing a short circuit with the various elements. In order to prevent heat damage of the various elements housed in the capsule 7, the insulating material 7c is preferably a material having a high heat-resistance such as ceramics.

The diaphragm 3 is electrically connected to a circuit pattern (not shown) formed on the substrate 1 through the conductive gate ring 2. The fixed electrode 5b of the back electrode plate 5 is electrically connected to the capsule 7 through the cap member 6, and in turn connected to the circuit pattern formed on the substrate 1 through the capsule 7. Further, an IC element 9 is provided on the substrate 1 to be electrically connected to the circuit pattern.

With the above-noted arrangement, when the diaphragm membrane 3b receives the sound wave and vibrates, displacement of the diaphragm 3b is transmitted to the IC element 9 as a change in capacitance of the capacitor section C (back electrode plate 5 and diaphragm 3). That means that the sound wave is converted to an electric signal at the ECM100.

The capsule 7 has an opening 8 formed in the top member 7a. The plate-like cap member 6 is provided between the capacitor section C noted above and the top member 7a of the capsule 7. The cap member 6 has acoustic holes 6a formed at portions exposed to the outside through the opening 8 for introducing the sound wave into the capacitor section C.

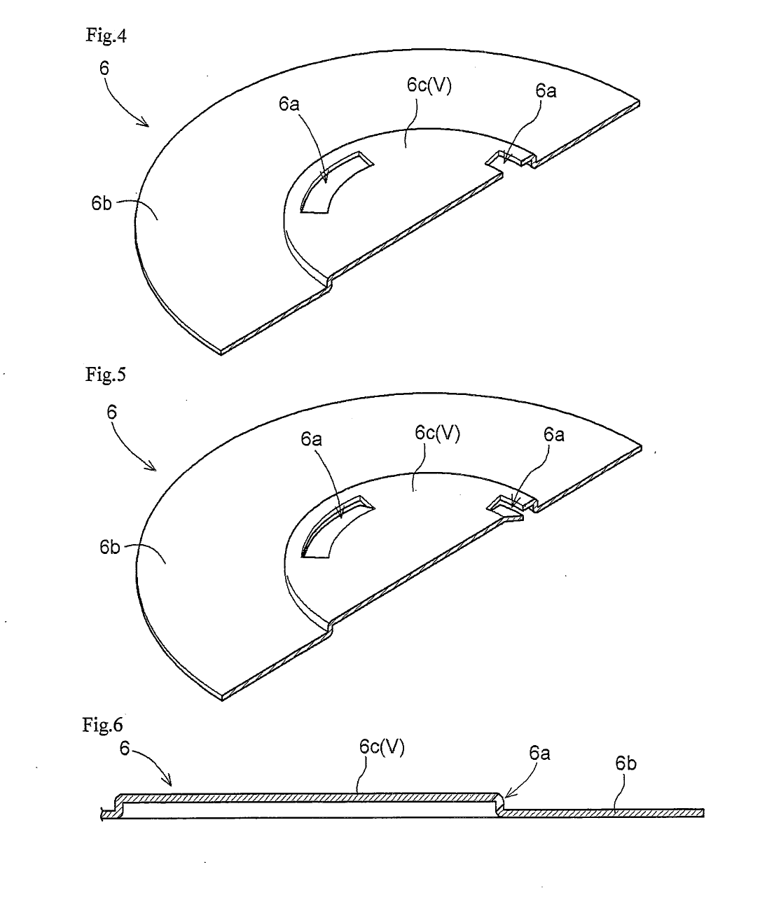

FIG. 3 shows a condition in which the cap member 6 is accommodated in the capsule 7, and FIG. 4 is a sectional perspective view of the cap member 6. As shown, the cap member 6 includes a peripheral first area 6b, and a second area 6c defined by a central portion surrounded by the first area 6b and projecting outward. The second area 6c formed in the central portion of the cap member 6 acts as a suctioned portion V to be drawn by a suction-type transportation device. It is enough for the suctioned portion V to have an area larger than a suction nozzle of the transportation device. This stabilizes a contacting condition between the suctioned portion V and an end face of the suction nozzle.

When the ECM100 is transported in a horizontal posture, the second area 6c is drawn at a center thereof to hold a portion of the ECM above the center of gravity. This can prevent the posture of the ECM100 from being changed when transported, which allows the ECM100 to fall off less easily. As a result, the drawing force of the transportation device can be reduced to prevent deformation of the capsule 7 and allows use of a small transportation device.

Further, even if the cap member 6 is heated, the heat is transmitted to the capacitor section C less easily because of a space defined between the cap member 6 and the capacitor section C provided in the interior of the capsule 7.

The acoustic holes 6a provided in the peripheries of the suctioned portion V acting as the second area 6c each have a shape of arc slit. Each of the acoustic holes 6a has an opening width smaller than a diameter of a conventional circular acoustic hole. This effectively prevents heated air, cooling air, dust and waterdrops from entering the interior of the capsule 7. More particularly, the acoustic holes 6a formed in the second area 6c of the cap member 6 are formed as the arc slits defined by grooves formed in the cap member 6. Alternatively, as shown in FIG. 5, the cap member 6 may be pushed in and bent to provide the acoustic holes 6a as the arc slits.

As shown in FIG. 2, in the ECM100 of the current embodiment, the acoustic holes 6a are arranged so as not to overlap the apertures 5c of the back electrode plate 5. Thus, even if foreign substances enter through the acoustic holes 6a, they are blocked by the back electrode plate 5. In other words, the foreign substances are prevented from entering to reach the diaphragm 3 through the apertures 5c of the back electrode plate 5. Further, air coming from the outside of the capsule 7 (heated air or cooling air in a reflow mounting process) is prevented from blowing directly against the diaphragm membrane 3b. In addition, the cap member 6 is provided between the capacitor section C (back electrode plate 5) and the top member 7a of the capsule 7, which alleviates the heat transmitted to the capacitor section C through the cap member 7 even if the temperature of the capsule 7 rises.

As a result, the capacitor section C is prevented from being adversely affected by the heat. More particularly, the heat influence exerted on the electret layer 5a provided in the capacitor section C can be reduced, which prevents polarization of the electret layer 5a from being deteriorated by the heat. In addition, the diaphragm 3 can be prevented from slackening by heated air or cooling air.

### MODIFIED EMBODIMENTS

<1> The design of the capacitor section C may vary as desired. For example, in the above-noted embodiment, the back electrode plate 5 is provided close to the cap member 6 in the capacitor section C housed in the capsule 7. Instead, the diaphragm 3 may be provided close to the cap member 6. Further, the diaphragm may include the electret layer, though the back electrode plate includes the electret layer in the above-noted embodiment.

<2> The acoustic holes 6a are arc slits in the above-noted embodiment. The shape or arrangement of the acoustic holes 6a may vary as desired. For example, the acoustic holes 6a may be a plurality of fine circular holes or rectangular holes continuously arranged in arc. Such an arrangement of the acoustic holes performs substantially the same function as the acoustic holes 6a comprising the arc slits.

Alternatively, the plurality of fine circular holes or rectangular holes noted above may be continuously arranged in a ring shape. Instead, the shape of the acoustic holes 6a may be arc slits, curved slits, straight slits or zigzag slits that are distributed radially from the center.

<3> The position where the acoustic holes are formed may be changed. For example, as shown in FIG. 6, the acoustic holes 6a may be formed in a boundary between the first area and the second area of the cap member. In this way, the acoustic holes 6a are formed with a predetermined angle relative to the first area 6b and the second area 6c, which prevents heated air, cooling air, dust and waterdrops more reliably from entering the capsule 7 easily, than the arrangement where the acoustic holes 6a are provided in the first area 6b or the second area 6c. This can improve durability and reliability of the ECM100.

In addition, even if the suction nozzle of the transporting device is brought into contact with a position deviated from the suctioned portion V, the suction nozzle would never seal the acoustic holes 6a, which can prevent the diaphragm 3 or the back electrode plate 5 arranged in the capsule 7 from being damaged.

### INDUSTRIAL APPLICABILITY

The present invention is applicable to the ECM adapting the reflow mounting technology.

1. An electret condenser microphone comprising:
a conductive capsule including an opening formed in a top member;
a capacitor section including a diaphragm, a back electrode plate arranged to face either surface of the diaphragm, and a electret layer provided on the diaphragm or the back electrode plate, all of which are housed in the capsule; and
a cap member provided between the capacitor section and the top member of the capsule and including an acoustic hole formed in a portion exposed to the outside through the opening;
wherein the cap member further includes a suctioned portion formed in a central portion thereof to be drawn by a transporting device, the acoustic holes being arranged along the circumference of the suctioned portion.

2. The electret condenser microphone as defined in claim 1 wherein the acoustic hole includes arc slits surrounding the circumference of the suctioned portion.

3. The electret condenser microphone as defined in claim 1, wherein the cap member includes a peripheral first area and a second area defined by a central portion surrounded by the first area and projecting outward, and the suctioned portion is formed in the second area.

4. The electret condenser microphone as defined in claim 3 wherein the acoustic hole is formed in the second area.

5. The electret condenser microphone as defined in claim 3 wherein the acoustic hole is formed in a boundary between the first area and the second area.
